(19) United States
(12) Patent Application Publication
(10) Pub. No.: US 2023/0265367 A1
(43) Pub. Date: Aug. 24, 2023

(54) Alcoholic Carbonated Beverages with Improved Taste

(71) Applicant: The Coca-Cola Company, Atlanta, GA (US)

(72) Inventors: Ben C. Williams, Alpharetta, GA (US); Prashanthi Jella, Lawrenceville, GA (US); John Fugate, Norcross, GA (US); Aaron Woody, Marietta, GA (US); Scott Michaluk, Atlanta, GA (US); Jose Sosa, Atlanta, GA (US); Fernando Carriedo, Lilburn, GA (US)

(21) Appl. No.: 18/003,931

(22) PCT Filed: Jul. 1, 2021
(86) PCT No.: PCT/US2021/040048

§ 371 Date: Dec. 30, 2022

Related U.S. Application Data
(60) Provisional application No. 63/047,010, filed on Jul. 1, 2020.

(51) Int. Cl. C12G 3/06

(52) U.S. Cl. CPC C12G 3/06

(57) ABSTRACT

Alcoholic carbonated beverages with improved flavor profiles are provided comprising (i) at least one food grade acidulant, (ii) at least one mineral salt and (iii) at least one flavor compound. Methods of preparing the alcoholic carbonated beverages described herein are also provided.

### CROSS-REFERENCE TO RELATED APPLICATION

This application claims priority to U.S. Provisional Pat. Application No. 63/047,010, filed Jul. 1, 2020, the contents of which are incorporated herein.

### FIELD OF THE INVENTION

Disclosed herein are alcoholic carbonated beverages comprising at least one food grade acidulant, at least one mineral salt and at least one flavor compound. Use of the at least one mineral salt improves the flavor profile of the beverage when compared to a corresponding beverage that does not contain the mineral salt. The present invention also extends to methods of preparing the alcoholic carbonated beverages described herein.

### BACKGROUND OF THE INVENTION

Consumers are increasingly seeking alternatives to traditional alcoholic carbonated beverages, e.g., beer and sparkling wine or champagne. Recently, hard seltzers (also called hard sparkling waters) have become overwhelmingly popular. The US hard seltzer market is expected to reach $2.5 billion by 2021. This segment includes White Claw Hard Seltzer, Truly Hard Seltzer, Smirnoff Sparkling Seltzer, Bon & Viv Spiked Seltzer, SVEDKA Spiked Premium Seltzer and Henry’s Hard Sparkling Water, among others. Hard seltzers contain at least carbonated water, alcohol, an acidulant and flavoring. The beverages are refreshing and flavorful but low in calories (most have between 90 to 110 calories per can), have a low sugar content, and have a relatively low alcohol content (e.g. 4-6% alcohol by volume (abv)). While flavorings are typically added, high amounts of sweetener typically are not. As such, hard seltzers are capitalizing on consumer demand for a healthier, natural, ready-to-drink alcoholic carbonated beverage.

The flavor profile of some hard seltzers, however, can frustrate consumers with various negative sensory attributes. Accordingly, there remains a need to for hard seltzers with improved flavor profiles and methods of preparing the same.

### SUMMARY OF THE INVENTION

In a first aspect, the present invention provides alcoholic carbonated beverages containing (i) at least one food grade acidulant, (ii) at least one mineral salt and (iii) at least one flavor compound.

Exemplary food grade acidulants include organic acids and their corresponding salts as well as inorganic acids and their corresponding salts. Two or more types of acidulants can be combined. The at least one food grade acidulant can be present in an amount from about 25 pm to about 25,000 ppm, more preferably from about 250 ppm to about 5,000 ppm. Preferred food grade acidulants include acetic acid, lactic acid, malic acid, fumaric acid, citric acid, tartaric acid, phosphoric acid, succinic acid, alkali or alkaline earth metal salts thereof, and combinations thereof.

The at least one mineral salt can be present in the beverage in an amount from about 1 ppm to about 100 ppm. Exemplary mineral salts include sodium chloride, magnesium chloride, potassium chloride, zinc chloride, sodium sulfate, magnesium sulfate, zinc sulfate, sodium carbonate, sodium bicarbonate, magnesium carbonate and potassium carbonate, potassium bicarbonate and combinations thereof.

In a particular embodiment, the mineral salt comprises potassium chloride and magnesium chloride. In a more particular embodiment, these salts are paired with the food grade acidulant citric acid. In such embodiments, particularly significant improvement in the beverage’s flavor profile is observed.

Exemplary flavor compounds include fruit flavors, herb flavors, spice flavors and combinations thereof. Other suitable flavors include allyl caproate, benzaldehyde, ethyl butyrate, limonene, citral, geranyl acetate, neryl acetate, octanal, nonanal, decanal, vanillin, ocimene, alpha ionone, beta ionone, maltol, furaneol, gamma-decalactone, gamma-octalactone ethyl acetate, linalool, hexyl acetate, cinnamaldehyde, citronellal, nerol, geraniol, alpha terpineol, valencene, (E,Z)-2,6-nonadienal, (E)-2-nonenal and combinations thereof.

The alcoholic carbonated beverages of the present invention optionally contain one or more sweeteners. Suitable sweeteners are natural or synthetic. The sweetener can be caloric or non-caloric, thereby impacting the overall caloric profile of the beverage. The sweetness of the beverage can be equivalent to 0.1 to about 8.0 degrees Brix. In one embodiment, the beverages are “lightly sweetened” and have a sweetness equivalent to 1.0 to about 5 degrees Brix.

The alcoholic carbonated beverages of the present invention can have from about 2.5% to about 10% alcohol by volume (abv), more particular from about 4% to about 6% abv.

The alcoholic carbonated beverages of the present invention can be full-calorie, mid-calorie, low-calorie or zero-calorie. Depending on the method of manufacture, they can also be gluten free.

In a second aspect, the present invention provides methods of preparing alcoholic carbonated beverages.

In one embodiment, a method of preparing an alcoholic carbonated beverage comprises adding the following beverage ingredients to a volume of still water: (i) ethanol, (ii) at least one food grade acidulant, (iii) at least one mineral salt, (iv) at least one flavor compound, (v) optionally, at least one sweetener and/or additive, and (vi) carbonation.

In an alternative embodiment, a method of preparing an alcoholic carbonated beverage comprises adding the following beverage ingredients to a volume of carbonated water: (i) ethanol, (ii) at least one food grade acidulant, (iii) at least one mineral salt, (iv) at least one flavor compound, and (v) optionally, at least one sweetener and/or additive.

In a further embodiment, a method of preparing an alcoholic carbonated beverage comprises (i) brewing neutral malt base to provide a clear wort, (ii) fermenting the clear wort to provide an alcoholic beverage base, and (iii) adding the beverage ingredients to the alcoholic beverage base to provide an alcoholic carbonated beverage, wherein the beverage ingredients comprise at least one food grade acidulant, at least one mineral salt, at least one flavor compound, carbonation and optionally, at least one sweetener and/or additive.

In a still further embodiment, a method of preparing an alcoholic carbonated beverage comprises (i) fermenting sugar, water and yeast to provide an alcoholic carbonated beverage base, and (ii) adding the beverage ingredients to the alcoholic carbonated beverage base, wherein the beverage ingredients comprise at least one food grade acidulant, at least one mineral salt, at least one flavor compound, and optionally, at least one sweetener and/or additive.

### DETAILED DESCRIPTION OF THE INVENTION

### I. Definitions

The term “astringency”, as used herein, refers to a perception puckering and dryness in the palate and is known to build in intensity and become increasingly difficult to clear from the mouth over repeated exposures. Astringency is a dry sensation experienced in the mouth and is commonly explained as arising from the loss of lubricity owing to the precipitation of proteins from the salivary film that coats and lubricates the oral cavity. Astringency is not confined to a particular region of the mouth but is a diffuse surface phenomenon, characterized by a loss of lubrication.

The term “bitter” or “bitter taste”, as used herein, refers to the perception or gustatory sensation resulting following the detection of a bitter tastant. The following attributes may contribute to bitter taste: astringent, bitter-astringent, metallic, bitter-metallic, as well as off-tastes, aftertastes and undesirable tastes including but not limited to freezer-burn and card-board taste, and/or any combinations of these. It is noted that, in the art, the term “off-taste” is often synonymous with “bitter taste. Bitterness of substances can be compared with bitter taste threshold of quinine which is 1. (Guyton, Arthur C. (1991) Textbook of Medical Physiology. (8th ed). Philadelphia: W.B. Saunders; McLaughlin S., Margolskee R.F. (1994). “The Sense of Taste”. American Scientist. 82 (6): 538-545.). Bitterness can be tested using a panel of subjects, as described herein, or in vitro, for example using a taste receptor cell line.

The term “carbonated beverage”, as used herein, refers to a beverage that contains bubbles of carbon dioxide.

The term “flavor profile,” as generally used herein, refers to the intensity of various flavor/taste attributes of a beverage. Exemplary flavor/taste attributes are sweetness intensity, bitterness intensity, salty intensity, licorice intensity, cooling intensity, and licorice intensity. Methods of determining the flavor profile of a given sweetener or sweetened composition are known in the art.

The term “licorice,” as used herein, refers to a sweet, semi-sweet, bitter, and/or aromatic taste of a sweetener or sweetened composition.

The term “mouthfeel”, as used herein, refers to the sensory and tactile properties of the consumable perceived when the composition contacts the mouth cavity and surfaces. The sensory and tactile properties include the texture, thickness, consistency and body.

The term “roundedness” or “rounded flavor”, as used herein, refers to a flavor profile that lacks sharp, harsh or unpleasant sensations. Beverages that have rounded flavor can also be described as “balanced.”

The term “sour” or “sourness”, as used herein, refers to a taste that detects acidity. It is caused by a hydrogen atom, or ions. The more atoms present in a food, the more sour it will taste. The sourness of substances is rated relative to dilute hydrochloric acid, which has a sourness index of 1. By comparison, tartaric acid has a sourness index of 0.7, citric acid an index of 0.46, and carbonic acid an index of 0.06. A reduction in sour taste can be expressed as percentage sour taste inhibition. In one embodiment, the taste modifying compositions of the present invention reduce sour taste of a consumable (e.g., a beverage) by at least about 5%, at least about 10%, at least about 15%, at least about 20% or at least about 25% or more relative to a consumable that does not contain the taste modifying composition.

The term “sweetening amount”, as used herein, refers to the amount of compound required to provide detectable sweetness when present in a beverage. A sweetener is present in a “sweetening amount” when it is above its sweetness recognition threshold concentration.

The term “sweetness recognition threshold concentration,” as used herein, is the lowest known concentration of a compound that is perceivable by the human sense of taste as sweet. The sweetness recognition threshold concentration is specific for a particular compound, and can vary based on temperature, matrix, ingredients and/or flavor system.

### II. Beverages

In one aspect, the present invention relates to alcoholic carbonated beverages containing (i) at least one food grade acidulant, (ii) at least one mineral salt, and (iii) at least one flavor compound. It has been found that, at certain concentrations, use of the at least one mineral salt improves the flavor profile of the beverage compared to a corresponding beverage without the at least one mineral salt. Additionally, certain combinations of at least one food acidulant and at least one mineral salt provide superior flavor profiles.

The alcoholic carbonated beverage can be any such known beverage in the art. In a preferred embodiment, the beverage is a hard seltzer, also known as a hard sparkling water.

### A. Food Grade Acidulants

The present beverages include at least one food grade acidulant. Food grade acidulants are well-known to those of skill in the art. Acidulants provide a sharp, zesty flavor. These acids give fruit its characteristic tang. Some are common in nature. For example, citric acid occurs naturally in citrus fruits such as oranges and lemons, malic acid is found in apples, and tartaric acid in grapes. Acidulants also have preservative and antioxidant properties.

Exemplary food grade acidulants include organic acids and their corresponding salts as well as inorganic acids and their corresponding salts. Two or more types of acidulants can be combined in the present beverages.

Exemplary organic acids include, but are not limited to, tannic acid, aconitic acid, lactic acid, tartaric acid, citric acid, isocitric acid, gluconic acid, glucoheptonic acids, adipic acid, hydroxycitric acid, malic acid, fruitaric acid (a blend of malic, fumaric, and tartaric acids), fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and their alkali or alkaline earth metal salts thereof.

Exemplary inorganic acidulants are include, but are not limited to, phosphoric acid, phosphorous acid, polyphosphoric acid, hydrochloric acid, sulfuric acid, carbonic acid, sodium dihydrogen phosphate, and alkali or alkaline earth metal salts thereof (e.g., inositol hexaphosphate Mg/Ca).

In a preferred embodiment, the food grade acidulant is selected from the group consisting of acetic acid, lactic acid, malic acid, fumaric acid, citric acid, tartaric acid, phosphoric acid, succinic acid, alkali or alkaline earth metal salts thereof, and combinations thereof.

Exemplary salt food grade acidulants include, but are not limited to, trisodium citrate, potassium gluconate, sodium gluconate, monosodium succinate, disodium succinate, sodium acetate, sodium tartrate, sodium lactate, monosodium fumarate, sodium malate.

The food grade acidulant can be present in the alcoholic carbonated beverage in an amount from about 25 ppm to about 25,000 ppm, such as, for example, from about 25 ppm to about 15,000 ppm, from about 25 ppm to about 10,000 ppm from about 25 ppm to about 5,000 ppm or from about 25 ppm to about 1,000 ppm.

In a preferred embodiment, the food grade acidulant is present in an amount from about 250 ppm to about 5,000 ppm, such as, for example, from about 250 ppm to about 4,000 ppm, from about 250 ppm to about 3,000 ppm, from about 250 ppm to about 2,000 ppm, from about 250 ppm to about 1,000 ppm, 250 ppm to about 500 ppm, from about 1,000 ppm to about 5,000 ppm, from about 1,000 ppm to about 4,000 ppm, from about 1,000 ppm to about 3,000 ppm, from about 1,000 ppm to about 2,000 ppm, from about 2,000 ppm to about 5,000 ppm, from about 2,000 ppm to about 4,000 ppm, from about 2,000 ppm to about 3,000 ppm, from about 3,000 ppm to about 5,000 ppm, from about 3,000 ppm to about 4,000 ppm, from about 4,000 ppm to about 5,000 ppm.

In a further embodiment, the food grade acidulant is citric acid. In a still further embodiment, the citric acid is present in an amount from about 250 ppm to about 5,000 ppm, such as, for example, from about 250 ppm to about 4,000 ppm, from about 250 ppm to about 3,000 ppm, from about 250 ppm to about 2,000 ppm, from about 250 ppm to about 1,000 ppm, 250 ppm to about 500 ppm, from about 1,000 ppm to about 5,000 ppm, from about 1,000 ppm to about 4,000 ppm, from about 1,000 ppm to about 3,000 ppm, from about 1,000 ppm to about 2,000 ppm, from about 2,000 ppm to about 5,000 ppm, from about 2,000 ppm to about 4,000 ppm, from about 2,000 ppm to about 3,000 ppm, from about 3,000 ppm to about 5,000 ppm, from about 3,000 ppm to about 4,000 ppm, from about 4,000 ppm to about 5,000 ppm.

### B. Mineral Salts

The present beverages include at least one mineral salt.

Minerals are selected from bulk minerals, trace minerals or combinations thereof. Non-limiting examples of bulk minerals include calcium, chlorine, magnesium, phosphorous, potassium, sodium, and sulfur. Non-limiting examples of trace minerals include chromium, cobalt, copper, fluorine, iron, manganese, molybdenum, selenium, zinc, and iodine. Although iodine generally is classified as a trace mineral, it is required in larger quantities than other trace minerals and often is categorized as a bulk mineral. Trace minerals are believed to be necessary for human nutrition, non-limiting examples of which include bismuth, boron, lithium, nickel, rubidium, silicon, strontium, tellurium, tin, titanium, tungsten, and vanadium.

For use in the present beverages, the above-reference minerals are provided in their salt form. Any known salt form can be used. Non-limiting examples of salt of the above minerals for use in the present beverages include chlorides, carbonates, sulfates, acetates, bicarbonates, citrates, phosphates, hydrogen phosphates, tartrates, sorbates, citrates, benzoates, gluconates or combinations thereof.

In one embodiment, the mineral salt is selected from sodium chloride, magnesium chloride, potassium chloride, calcium chloride, zinc chloride, sodium sulfate, magnesium sulfate, zinc sulfate, sodium carbonate, sodium bicarbonate, magnesium carbonate, potassium carbonate, potassium bicarbonate, calcium carbonate and combinations thereof.

In preferred embodiments, the mineral salt is not a calcium salt as such compounds were found to provide a “chalky taste.” In such embodiments, the mineral salt is selected from sodium chloride, magnesium chloride, potassium chloride, zinc chloride, sodium sulfate, magnesium sulfate, zinc sulfate, sodium carbonate, sodium bicarbonate, magnesium carbonate and potassium carbonate, potassium bicarbonate and combinations thereof.

The mineral salt can be present in the alcoholic carbonated beverage in an amount from about 1 ppm to about 100 ppm, such as, for example, from about 1 ppm to about 75 ppm, from about 1 ppm to about 50 ppm, from about 1 ppm to about 25 ppm, from about 10 ppm to 100 ppm, from about 10 ppm to about 75 ppm, from about 10 ppm to about 50 ppm, from about 10 ppm to about 25 ppm, from about 25 ppm to about 100 ppm, from about 25 ppm to about 75 ppm, from about 25 ppm to about 50 ppm, from about 50 ppm to about 100 ppm, from about 50 ppm to about 75 ppm and from about 75 ppm to about 100 ppm.

In a particular embodiment, the mineral salt is sodium chloride in an amount from about 1 ppm to about 100 ppm. Levels below 1 ppm were found to have no discernible effect, while levels above 100 ppm were described by taste panelists as “salty.”

In another particular embodiment, the mineral salt is magnesium sulfate in an amount from about 1.5 ppm to about 60 ppm.

In still another particular embodiment, the mineral salt is magnesium chloride in an amount from about 2 ppm to about 45 ppm, from about 5 ppm to about 40 ppm, from about 5 ppm to about 35 ppm, from about 5 ppm to about 30 ppm, from about 5 ppm to about 25 ppm, from about 5 ppm to about 20 ppm, from about 10 ppm to about 45 ppm, from about 10 ppm to about 40 ppm, from about 10 ppm to about 35 ppm, from about 10 ppm to about 30 ppm, from about 10 ppm to about 25 ppm, from about 10 ppm to about 20 ppm, from about 20 ppm to about 45 ppm, from about 20 ppm to about 40 ppm, from about 20 ppm to about 35 ppm, from about 20 ppm to about 30 ppm, from about 30 ppm to about 45 ppm or from about 30 ppm to about 40 ppm.

In yet another embodiment, the mineral salt is potassium chloride in an amount from about 0.2 ppm to about 35 ppm. Levels above 35 ppm were described as providing negative taste properties, e.g. bitterness and metallic tastes. In a particular embodiment, the potassium chloride is present in an amount from about 1 ppm to about 30 ppm, from about 1 ppm to about 20 ppm, from about 1 ppm to about 10 ppm, from about 5 ppm to about 30 ppm, from about 5 ppm to about 20 ppm or from about 5 ppm to about 10 ppm.

In a still further embodiment, the mineral salt is zinc sulfate in an amount from about 0.1 ppm to about 20 ppm.

In another further embodiment, the mineral salt is potassium bicarbonate in an amount from about 2 ppm to about 40 ppm.

It has also been found that certain combinations of mineral salts provide superior results. In one embodiment, the beverage comprises at least two mineral salts, at least three mineral salts or at least four mineral salts. In particular, the combination of potassium chloride and magnesium chloride in the above-specified ranges provides significant improvement in the beverage’s flavor profile.

### C. Flavors

The present beverages include at least one flavor compound. “Flavor compound”, “Flavorant” and “flavoring ingredient” are interchangeable and includes natural or synthetic substances or combinations thereof which are safe for human or animal consumption when used in a generally accepted range. GRAS flavor compounds are known in the art. Any flavor compound can be used.

In one embodiment, the flavor compound is a fruit flavor, a herb flavor, a spice flavor or a combination thereof.

Suitable fruit flavors include, but are not limited to, apple, apricot, avocado, banana, blackberry, black currant, blueberry, breadfruit, cantaloupe, carambola, cherimoya, cherry, black cherry, clementine, coconut, cranberry, custard-apple, date, durian, elderberry, feijoa, fig, gooseberry, grapefruit, grape, guava, honeydew melon, jackfruit, java-plum, jujube fruit, kiwifruit, kumquat, lemon, lime, longan, loquat, lychee, mandarin, mango, mangosteen, mulberry, nectarine, orange, papaya, passion fruit, peach, pear, persimmon, pitaya (dragonfruit), pineapple, pitanga, plantain, plum, pomegranate, prickly pear, prune, pummelo, quince, raspberry, rhubarb, rose-apple, sapodilla, sapote, soursop, strawberry, sugar-apple, tamarine, tangerine, watermelon and combinations thereof.

In one embodiment, the fruit flavor is selected from the group consisting of lemon, lime, pineapple, strawberry, guava and combinations thereof. In one particular embodiment, the fruit flavor comprises lemon and lime. In another particular embodiment, the fruit flavor is pineapple. In still another particular embodiment, the fruit flavor comprises strawberry and guava.

Other flavor compounds suitable for use in the present beverages include tea (for example, black, white, red, oolong and green tea), aloe vera, guarana, ginseng, gingko, hawthorn, hibiscus, rosehips, chamomile, peppermint, fennel, ginger, licorice, lotus seed, schizandra, saw palmetto, sarsaparilla, safflower, St. John’s wort, curcuma, cardamom, nutmeg, cassia bark, buchu, cinnamon, jasmine, haw, chrysanthemum, water chestnut, sugar cane, lychee, bamboo shoots, vanilla, coffee, basil, hibiscus, elderflower, cucumber, vanilla, citrus, almond and menthol.

Still other exemplary flavor compounds include allyl caproate, benzaldehyde, ethyl butyrate, limonene, citral, geranyl acetate, neryl acetate, octanal, nonanal, decanal, vanillin, ocimene, alpha ionone, beta ionone, maltol, furaneol, gamma-decalactone, gamma-octalactone ethyl acetate, linalool, hexyl acetate, cinnamaldehyde, citronellal, nerol, geraniol, alpha terpineol, valencene, (E,Z)-2,6-nonadienal and (E)-2-nonenal.

The at least one flavor compound is present in an amount from about 0.1 ppm to about 4,000 ppm, such as, for example, from about 1 ppm to about 4,000 ppm, from about 1 ppm to about 3,000 ppm, from about 1 ppm to about 2,000 ppm, from about 1 ppm to about 1,000 ppm or from about 1 ppm to about 500 ppm.

### D. Sweetener

The present beverages can optionally include at least one sweetener. The sweetness of the present beverages can be from 0.1 to about 8.0 degrees Brix (°Bx). One degree Brix is the sweetness of 1 gram of sucrose in 100 grams of solution and represents the strength of the solution as percentage by weight (% w/w) (strictly speaking, by mass).

In one embodiment, the beverage does not include a sweetener, i.e. it is “unsweetened.”

In other embodiments, the beverage includes at least one caloric or non-caloric sweetener, i.e. it is “sweetened.” In one such embodiment, the beverage is “lightly sweetened,”, i.e. it has a sweetness equivalent to 0.1 °Bx to about 5 °Bx, from about 0.1 °Bx to about 4 °Bx, from about 0.1 °Bx to about 3 °Bx, from about 0.1 °Bx to about 2 °Bx, from about 0.1 °Bx to about 1 °Bx, from about 1 °Bx to about 5 °Bx, from about 1 °Bx to about 4 °Bx, from about 1 °Bx to about 3 °Bx or from about 1 °Bx to about 2 °Bx. In another embodiment the beverage has a sweetness equivalent to 0.5 °Bx to about 5 °Bx, from about 0.5 °Bx to about 4 °Bx, from about 0.5 °Bx to about 3 °Bx, from about 0.5 °Bx to about 2 °Bx and from about 0.5 °Bx to about 1 °Bx.

The sweetener can be any known sweetener, e.g. a natural sweetener, a natural high potency sweetener or a synthetic sweetener.

Suitable sweeteners include carbohydrate sweeteners selected from the group consisting of sucrose, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, fucose, rhamnose, arabinose, turanose, sialose and combinations thereof.

Other suitable sweeteners include rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M, dulcoside A, dulcoside B, rubusoside, stevia, stevioside, mogroside IV, mogroside V, monk fruit, Luo han guo, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, steviolbioside and cyclocarioside I, sugar alcohols such as erythritol, sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs) and combinations thereof.

Other suitable sweeteners include rare sugars selected from the group consisting of allulose, sorbose, lyxose, ribulose, xylose, xylulose, D-allose, L-ribose, D-tagatose, L-glucose, L-fucose, L-arabinose, turanose and combinations thereof.

In a particular embodiment, the sweetener is sucrose and the beverage is equivalent to 0.5 °Bx to about 5 °Bx, from 0.5 °Bx to about 2 °Bx or from 0.5 °Bx to about 1 °Bx.

### E. Additives

The present beverages can optionally include one or more beverages additives, e.g. coloring agents, preservatives, emulsifiers, antioxidants, amino acids, caffeine, micronutrients, plant extracts, phytochemicals (“phytonutrients”), salts including buffering salts, stabilizers, thickening agents, vitamins, and combinations thereof.

Suitable coloring agents include, but are not limited to, FD&C dyes (e.g., yellow no. 5, blue no. 2, red no. 40) and/or FD&C lakes. Additionally, a mixture of FD&C dyes or FD&C lake dye in combination with other conventional food and food colorants may be used. Riboflavin and beta carotene may also be used. Additionally, other natural coloring agents may be used including, for example, fruit, vegetable, and/or plant extracts such as grape, black currant, aronia, carrot, beet root, red cabbage, hibiscus, anthocyanins, betalins, turmeric, curcumin, annatto, carotenoids, cochineal, carminic acid, and carmine. The amount of coloring agent used will vary, depending on the identity of the agents used and the intensity of color desired in the finished product. These materials are used at their conventional art-established levels.

Preservatives may or may not be needed. Techniques such as aseptic, hot fill, tunnel pasteurization, ultrahigh temperature (UHT) retort, and/or clean fill processing may be utilized to avoid the need for preservatives. One or more preservatives may, however, optionally be added to the present beverages at their art-established levels. Preferred preservatives include, for example, sorbate, benzoate, and polyphosphate preservatives (for example, sodium hexametapolyphosphate).

### F. Beverage Properties

The beverage contains from about 2.5% to about 10% ethanol by volume (abv), such as, for example, from about 2.5% to about 8%, from about 3% to about 7%, from about 3% to about 6%, from about 4% to about 8%, from about 4% to about 7% or from about 4% to about 6%. In a particular embodiment, the beverage has from about 4% to about 6% abv.

The beverage contains from about 1.5 to about 4.5 volumes of carbon dioxide per volume of liquid.

The pH of the beverage may be from about 1.8 to about 10, such as, for example, from about 1.8 to about 7, from about 2 to about 6, from about 2 to about 5, from about 3 to about 5 or from about 3 to about 4. In a particular embodiment, a hard seltzer of the present invention has a pH from about 3 to about 5 or about 3 to about 4.

The temperature of a beverage may, for example, range from about 4° C. to about 25° C.

The beverage serving size is about 355 mL. In preferred embodiments, the beverage has a calorie content from about 50 to about 150 calories per serving, from about 75 to about 150 calories per serving or from about 100 to about 150 calories per serving. In a particular embodiment, the beverage has from about 90 to about 100 calories per serving, from about 90 to about 110 calories per serving, from about 90 to about 120 calories per serving.

The beverage can be a zero-calorie that has less than about 5 calories per 8 oz. serving.

The beverage can be gluten-free.

In one embodiment, an alcoholic carbonated beverage comprises (i) at least one food grade acidulant, (ii) at least one mineral salt, and (iii) at least one flavor compound, wherein the beverage optionally includes at least one sweetener.

In a more particular embodiment, an alcoholic carbonated beverage comprises (i) at least one food grade acidulant in an amount from about 250 ppm to about 5,000 ppm, (ii) at least one mineral salt in an amount from about 1 ppm to about 100 ppm, and (iii) at least one flavor compound, wherein the beverage optionally includes at least one sweetener.

In a more particular embodiment, an alcoholic carbonated beverage comprises (i) at least one food grade acidulant selected from the group consisting of acetic acid, lactic acid, malic acid, fumaric acid, citric acid, tartaric acid, phosphoric acid, succinic acid, alkali or alkaline earth metal salts thereof, and combinations thereof in an amount from about 250 ppm to about 5,000 ppm, (ii) at least one mineral salt, and (iii) at least one flavor compound, wherein the beverage optionally includes at least one sweetener.

In another more particular embodiment, an alcoholic carbonated beverage comprises (i) at least one food grade acidulant, (ii) at least one mineral salt selected from the group consisting of sodium chloride, magnesium chloride, potassium chloride, zinc chloride, sodium sulfate, magnesium sulfate, zinc sulfate, sodium carbonate, sodium bicarbonate, magnesium carbonate and potassium carbonate, potassium bicarbonate and combinations thereof, in an amount from about 1 ppm to about 100 ppm, and (iii) at least one flavor compound, wherein the beverage optionally includes at least one sweetener.

In an even more particular embodiment, an alcoholic carbonated beverage comprises (i) at least one food grade acidulant selected from the group consisting of acetic acid, lactic acid, malic acid, fumaric acid, citric acid, tartaric acid, phosphoric acid, succinic acid, alkali or alkaline earth metal salts thereof, and combinations thereof, in an amount from about 250 ppm to about 5,000 ppm, (ii) at least one mineral salt selected from the group consisting of sodium chloride, magnesium chloride, potassium chloride, zinc chloride, sodium sulfate, magnesium sulfate, zinc sulfate, sodium carbonate, sodium bicarbonate, magnesium carbonate and potassium carbonate, potassium bicarbonate and combinations thereof, in an amount from about 1 ppm to about 100 ppm, and (iii) at least one flavor compound, wherein the beverage optionally includes at least one sweetener.

The beverages of the present invention have improved flavor profiles compared to a corresponding beverage without the at least one mineral salt. The flavor profile of a sweetener is a quantitative profile of the relative intensities of all of the taste attributes exhibited. Such profiles often are plotted as histograms or radar plots. For example, beverages of the present invention have one or more of the following: reduced bitterness, reduced astringency, reduced licorice notes, reduced sweetness linger, reduced bitterness linger, reduced bitterness aftertaste, reduced metallic aftertaste, reduced chemical aftertaste, improved mouthfeel or more rounded flavor. These attributes can be measured using a trained sensory pained by methods known to those of skill in the art.

### III. Methods

In one aspect, methods of preparing the alcoholic carbonated beverages of the present invention are provided.

In a first general method, the ethanol is added to water or carbonated water to provide an alcoholic carbonated beverage. This method is referred to as “spiking.”

One method of preparing an alcoholic carbonated beverage comprises adding the following beverage ingredients to a volume of still water: (i) ethanol, (ii) at least one food grade acidulant, (iii) at least one mineral salt, (iv) at least one flavor compound, (v) optional at least one sweetener and/or additive, and (vi) carbonation.

The water in can be distilled or deionized water.

Another method of preparing an alcoholic carbonated beverage comprises adding the following beverage ingredients to a volume of carbonated water: (i) ethanol, (ii) at least one food grade acidulant, (iii) at least one mineral salt, (iv) at least one flavor compound, and (v) optionally, at least one sweetener and/or additive. The beverage ingredients can be added in any order to the carbonated water.

In the second general method, fermentation is used on either a brewed-malt (“clear malt”) or brewed-sugar (where 100% of the fermentables are derived from non-malt sugar) base to provide an alcoholic beverage base to which the remaining beverage ingredients are added.

In the brewed-malt process, neutral malt base (stripped of flavors, colors and odors) is brewed to provide a clear wort. The wort is then fermented to provide an alcoholic beverage base. The beverage ingredients (i.e. at least one food grade acidulant, at least one mineral salt, at least one flavor compound, carbonation and optionally, at least one sweetener and/or additive) are then added to the alcoholic beverage base to provide the alcoholic carbonated beverage of the present invention.

In the brewed-sugar process, sugar, water and yeast are combined. The mixture ferments into an alcoholic carbonated beverage base (i.e. hard seltzer). The beverage ingredients (i.e. at least one food grade acidulant, at least one mineral salt, at least one flavor compound, and optionally, at least one sweetener and/or additive) are then added to the alcoholic carbonated beverage base to provide the alcoholic carbonated beverage of the present invention.

In any of the above-described methods, the alcoholic carbonated beverage can be dispensed into a container and sealed. Exemplary containers include single-serving cans and single-serving bottles.

### EXAMPLES

### Example 1: Preparation of an Exemplary Beverage

An alcoholic carbonated beverage was prepared by following the following steps:
1) Add purified water, reserving some for rinsing
2) Add sugar and mix for 15 min
3) Add ethanol and mix for 10 min
   a. Note: Tank may get warm
4) Add Part A (Citric Acid), mix until dissolved
5) Add Part B (Buffer), mix until dissolved
6) Add Part C (Minerals), mix until dissolved
7) Add Part D (Flavors), mix until homogenous
8) Add Part F (Flavors)
9) Mix for at least 30 minutes
10) Blend mix to a 1:5 ratio with carbonated water

### Example 2: Sensory Study

The following three test beverages were prepared:

| | | | |
|---|---|---|---|
| Ingredient | Tangy Lemon Lime | Pineapple Twist | Strawberry Guava |
| Potassium Chloride | 6.5 ppm (3.42 ppm of K) | 6.5 ppm (3.42 ppm of K) | 6.5 ppm (3.42 ppm of K) |
| Magnesium Chloride | 32.5 ppm (3.9 ppm of Mg) | 32.5 ppm (3.9 ppm of Mg) | 32.5 ppm (3.9 ppm of Mg) |
| Ethanol | 4.7% | 4.7% | 4.7% |
| Citric Acid | 800 ppm | 800 ppm | 800 ppm |
| Flavor Compound | Limonene+other flavors | Allyl Caproate+other flavors | Ethyl butyrate+other flavors |
| Sweetener | 0.57 °Brix sucrose | 0.57 °Brix sucrose | 0.57 °Brix sucrose |
| | Water | Water | Water |
| Carbonation | 2.5 vol | 2.5 vol | 2.5 vol |

Corresponding control beverages were prepared that differed only in the absence of potassium chloride and magnesium chloride.

An expert panel compared the taste, flavor and mouthfeel of the test beverages to the control beverages. The samples were tested in pairs (test and control for each flavor). Each panelist ate 0.5-1 unsalted cracker and sipped water between pairs. Each panelist was served 2 oz of chilled beverage in a cup and asked to drink enough to form an opinion. Panelists filled-out a questionnaire with the following questions:
Which samples has a better taste?
Which sample has better flavor perception?
Which sample has more mouthfeel?

The results are provided in the table below.

| | Test Beverage | Control |
|---|---|---|
| Taste | | |
| Tangy Lemon Lime | 60% | 40% |
| Pineapple Twist | 80% | 20% |
| Strawberry Guava | 60% | 40% |
| Flavor | | |
| Tangy Lemon Lime | 80% | 20% |
| Pineapple Twist | 50% | 50% |
| Strawberry Guava | 60% | 40% |
| Mouthfeel | | |
| Tangy Lemon Lime | 60% | 40% |
| Pineapple Twist | 50% | 50% |
| Strawberry Guava | 80% | 20% |

The % reported corresponds to the number of panelists that selected the test or control beverage as having better taste, flavor or mouthfeel. Bold percentages indicate a significant difference at 95% confidence level. The test beverages had significantly better taste across all three test beverages. The test beverages had significantly better flavor perception for Tangy Lemon Lime and Strawberry Guava. The test beverages had significantly better mouthfeel for Tangy Lemon Lime and Strawberry Guava.

1. An alcoholic carbonated beverage comprising (i) at least one food grade acidulant (ii) at least one mineral salt and (iii) at least one flavor compound.

2. The beverage of claim 1, wherein the at least one food grade acidulant is present in an amount from about 250 ppm to about 5,000 ppm.

3. The beverage of claim 2, wherein the at least one food grade acidulant is selected from the ground consisting of acetic acid, lactic acid, malic acid, fumaric acid, citric acid, tartaric acid, phosphoric acid, succinic acid, alkali or alkaline earth metal salts thereof, and combinations thereof.

4. The beverage of claim 1, wherein the at least one mineral salt is present in an amount from about 1 ppm to about 100 ppm.

5. The beverage of claim 1, wherein the at least one mineral salt is selected from the group consisting of sodium chloride, magnesium chloride, potassium chloride, zinc chloride, sodium sulfate, magnesium sulfate, zinc sulfate, sodium carbonate, sodium bicarbonate, magnesium carbonate and potassium carbonate, potassium bicarbonate and combinations thereof.

6. The beverage of claim 5, wherein the mineral salt is selected from:
a. sodium chloride in an amount from about 1 ppm to about 100 ppm;
b.,magnesium chloride in an amount from about 2 ppm to about 45 ppm;
c. magnesium sulfate in an amount from about 1.5 ppm to about 60 ppm;
d. potassium chloride in an amount from about 0.2 ppm to about 35 ppm;
e. zinc sulfate in an amount from about 0.1 ppm to about 20 ppm; and
f. potassium bicarbonate in an amount from about 2 ppm to about 40 ppm.

7. The beverage of claim 5, wherein the mineral salt is a combination of potassium chloride and magnesium chloride.

8. The beverage of claim 7, wherein the at least one acidulant is citric acid.

9. The beverage of claim 8, wherein the citric acid is present in an amount from about 250 ppm to about 5,000 ppm.

10. The beverage of claim 1, wherein the flavor compound is selected from the group consisting of allyl caproate, benzaldehyde, ethyl butyrate, limonene, citral, geranyl acetate, neryl acetate, octanal, nonanal, decanal, vanillin, ocimene, alpha ionone, beta ionone, maltol, furaneol, gamma-decalactone, gamma-octalactone ethyl acetate, linalool, hexyl acetate, cinnamaldehyde, citronellal, nerol, geraniol, alpha terpineol, valencene, (E,Z)-2,6-nonadienal, (E)-2-nonenal and combinations thereof.

11. The beverage of claim 1, further comprising at least one sweetener.

12. The beverage of claim 11, wherein the sweetener is caloric.

13. The beverage of claim 11, wherein the sweetener is non-caloric.

14. The beverage of claim 11, wherein the at least one sweetener is selected from the group consisting of sucrose, dextrose, fructose, erythritol, sucralose, steviol glycosides or stevia, monk fruit (Luo Han Guo), aspartame and acesulfame K and combinations thereof.

15. The beverage of claim 1, wherein the beverage has a sweetness equivalent to 0.1 degrees Brix to about 8 degrees Brix.

16. The beverage of claim 1, wherein the beverage is unsweetened.

17. The beverage of claim 1, wherein the alcohol content is from about 2% to about 8% by volume (abv).

18. The beverage of claim 1, wherein the beverage is a mid-calorie or low-calorie beverage having an alcohol content from about 2% to about 8% by weight.

19. A container comprising the beverage of claim 1.

20. The container of claim 19, wherein the container is selected from a bottle or a can.
